(19) United States
(12) Patent Application Publication
(10) Pub. No.: US 2013/0311244 A1
(43) Pub. Date: Nov. 21, 2013

(54) Computer Automated System for Selecting, Tracking, and Rating Workers

(71) Applicant: David D. Abotchie, Braintree, MA (US)

(72) Inventor: David D. Abotchie, Braintree, MA (US)

(21) Appl. No.: 13/873,699

(22) Filed: Apr. 30, 2013

Related U.S. Application Data
(60) Provisional application No. 61/647,561, filed on May 16, 2012.
(60) Provisional application No. 61/780,571, filed on Mar. 13, 2013.

(51) Int. Cl. G06Q 10/06

(52) U.S. Cl. CPC G06Q 10/06393
USPC 705/7.39

(57) ABSTRACT

Computer automated system for selected, tracking and rating workers. One embodiment of the present invention provides, to a first user, a plurality of outputs representing a plurality of questions relating to the first user's technical skill. A plurality of inputs representing a plurality of answers to the plurality of questions is received from the first user. A technical comfort score representing the first user's comfort with technology is identified based on the plurality of answers. A determination is then made whether the technical comfort score satisfies a first criterion.

### CROSS REFERENCE TO RELATED APPLICATIONS

This application claims priority from U.S. Provisional Patent Application Ser. No. 61/647,561, filed on May 16, 2012, entitled “A Computer-Automated System for Selecting, Tracking, and Rating Employees” (Attorney Docket No. A0017-1001L), and U.S. Provisional Patent Application Ser. No. 61/780,571, filed on Mar. 13, 2013, entitled “Selecting, Tracking and Rating Workers” (Attorney Docket No. A0017-1001L2), each of which is hereby incorporated by reference.

### BACKGROUND

There are different approaches to finding and hiring workers (e.g., employees and freelance service providers). With the advent of the Internet, many online marketplace systems were developed to help and facilitate access to service providers and their services. These prior art systems and related methods, however, are not efficient in selecting, tracking, and rating workers or service providers because such systems do not provide comprehensive guidance to potential employers as to selecting, tracking, and rating workers.

### SUMMARY

In view of the above, there is a strong need for a computer-automated system and related method that facilitates selection, tracking, and rating of workers in an efficient and effective manner.

It is therefore an aspect of the present invention to provide a computer automated system and related method for conveniently and efficiently selecting, tracking, and rating workers.

It is further aspect of the present invention to provide a system that is easy to use for employers as well as for workers.

It is yet further aspect of the present invention to provide a system and related method that provide employers with effective project management tools.

For example, one embodiment of the present invention provides, to a first user, a plurality of outputs representing a plurality of questions relating to the first user's technical skill. A plurality of inputs representing a plurality of answers to the plurality of questions is received from the first user. A technical comfort score representing the first user's comfort with technology is identified based on the plurality of answers. A determination is then made whether the technical comfort score satisfies a first criterion.

In another embodiment of the present invention, input representing a skill to require for a job may be received from a first user. The job is associated with a first job category. A determination is made whether the skill is a permissible skill to associate with jobs associated with the first job category. If the skill is determined to be a permissible skill to associate with the first job category, then the skill is associated with a job profile associated with the job. If the skill is not determined to be a permissible skill to associate with the first job category, then the skill is not associated with the job profile associated with the job.

In another embodiment of the present invention an aptitude score of a worker on an aptitude test associated with a plurality of skills is identified. The plurality of skills is associated with a job. Technical feature data representing a technical feature associated with a computer of the worker is identified. A job submission rating representing a number of jobs to which the worker has submitted late work assignments is identified. An interview score of the worker on an interview test associated with the job is identified. A job applicant score associated with the worker and the job is calculated based on the aptitude score, the technical feature data, the job submission rate, and the interview score.

In another embodiment of the present invention input representing a first plurality of skills is received from a worker. For each skill in the first plurality of skills: a profile question set associated with a skill is provided to the worker; an answer to each question in the profile question set is received from the worker; a determination is made whether the answers received satisfy a criterion; an indication that the worker is certified in skill is stored in a profile of the worker only if the answers received are determined to satisfy the criterion.

In another embodiment of the present invention a first computer obtains, from a second computer, job application input representing a job application of a job applicant. The job application input includes technical feature data representing a technical feature associated with the second computer. A determination is made whether the technical feature data satisfies a first criterion. If the technical feature data is determined to satisfy the first criterion, job application rejection data indicating a rejection of the job application is sent to the first computer.

In another embodiment of the present invention question data representing a question sent by an employer via a first computer to a second computer associated with a worker is received. A first time at which the question was sent by the first computer is identified. Answer data representing an answer to the question sent by the worker via the second computer to the first computer is received. A second time at which the answer was received by the first computer is identified. A difference between the first time and the second time is calculated. A score representing an evaluation of work of the worker based on the difference between the first time and the second time is generated.

Other features and advantages of various aspects and embodiments of the present invention will become apparent from the following description and from the claims.

### BRIEF DESCRIPTION OF THE DRAWINGS

FIG. 1 is a schematic representation of a computer automated system for selecting, tracking, and rating workers in accordance with an embodiment of the present invention.

FIG. 2 is a flowchart of a method of using the system shown in FIG. 1 in accordance with an embodiment the present invention.

FIG. 3 is a flowchart of an employer technical assessment method according to an embodiment of the present invention.

FIG. 4 is a schematic representation of an employer technical assessment user interface according to an embodiment of the present invention.

FIG. 5 is a schematic representation of an automated guidance system in accordance with an embodiment of the present invention.

FIG. 6 is a flowchart of a skills guidance method according to an embodiment of the present invention.

FIG. 7 is a schematic representation of a job post screening process in accordance with an embodiment of the present invention.

FIG. 8 is a flowchart of a worker skill verification method according to an embodiment of the present invention.

FIG. 9 is a schematic representation of a worker skill verification user interface according to an embodiment of the present invention.

FIG. 10 which is a flowchart of a certification screening method according to an exemplary embodiment of the present invention.

FIG. 11 is a schematic representation of an aptitude test in accordance with an embodiment of the present invention.

FIG. 12 is a flowchart of an aptitude assessment method according to an embodiment of the present invention.

FIG. 13 is a schematic representation of an aptitude assessment user interface according to an embodiment of the present invention.

FIG. 14 is a schematic representation of a process of download speed rating in accordance with an embodiment of the present invention.

FIG. 15 is a flowchart of a technical feature assessment method according to an embodiment of the present invention.

FIG. 16 is a schematic representation of a recruiting stage in accordance with an embodiment of the present invention.

FIG. 17 is a screenshot of a user interface used during a recruit stage in accordance with an embodiment of the present invention.

FIG. 18 is a flowchart of a worker evaluation method according to an embodiment of the present invention.

FIG. 19 is schematic representation of a rating of a message response time in accordance with an embodiment of the present invention.

FIG. 20 is a flowchart of a communication response time assessment method in accordance with an embodiment of the present invention.

FIG. 21 is a schematic representation of a job submission in accordance with an embodiment of the present invention.

### DETAILED DESCRIPTION

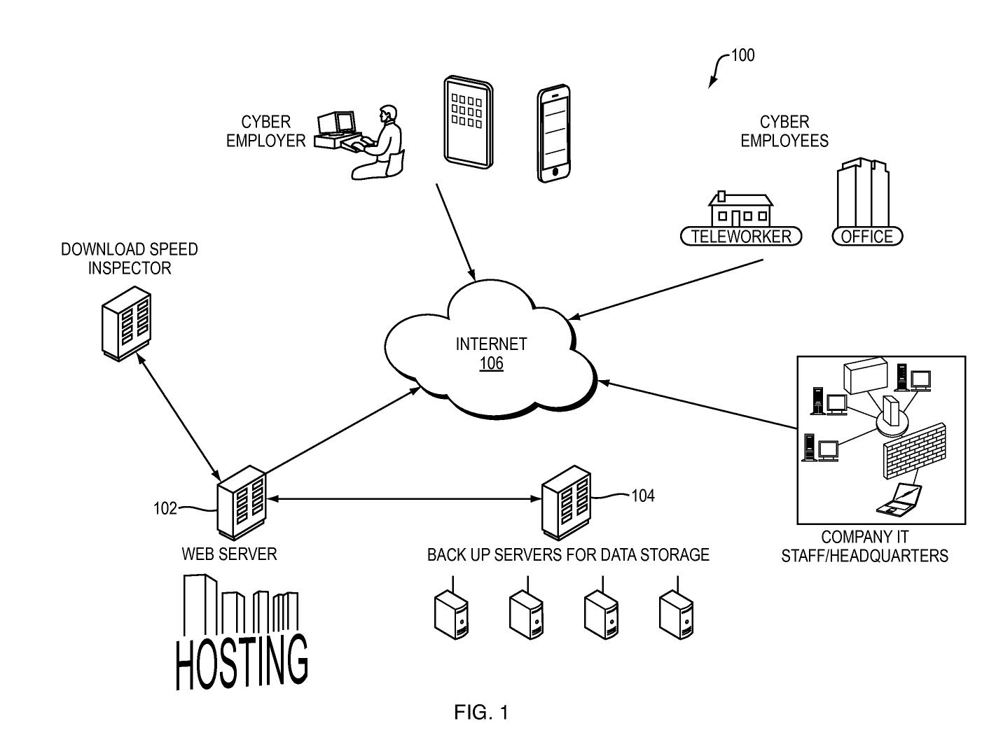

FIG. 1 is a schematic representation of a computer automated system for selecting, tracking, and rating workers in accordance with an embodiment of the present invention. The system may include a web server 102, a backup server 104 for data storage, a database maintained on the web server 102 or the backup server 104, and a web-based application with a user-friendly interface. It is to be understood that for purposes of this disclosure, that although reference may be made a particular quantity of an element (e.g., a single device such as a web server or a single operation such as administering a profile test as discussed below), the actual quantity of such elements may differ (e.g., multiple webservers may be included, more than one profile test may be administered). Turning back to the system of FIG. 1, potential employers and workers may access the system over a public network, such as the Internet 106. Alternatively, an embodiment of the present invention may be implemented over a private network, such as an intranet.

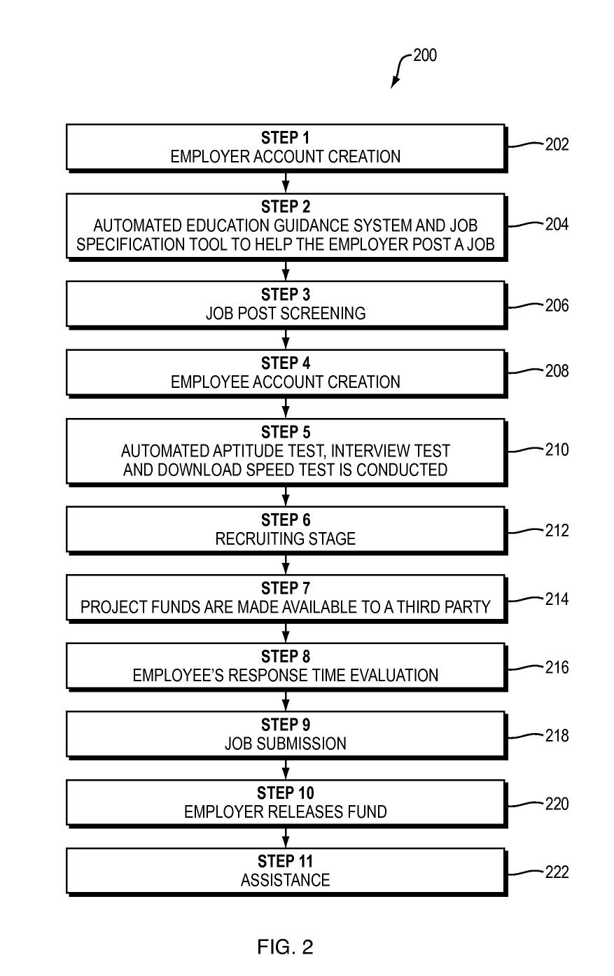

As shown in FIG. 2, a system such as the system 100 of FIG. 1 may enable an employer to create an account (operation 202), to use an automated education guidance system and job specification tool to help the employer post a job (operation 204) and to screen job postings (operation 206). The system may also be configured to enable a worker to create an account (operation 208), to administer a profile test, an aptitude test, an interview test, and a download speed test (operation 210). Then the employer may advance to a recruiting stage (operation 212). The profile test may be provided to the worker for each skill in which the worker claims to be proficient. The aptitude test may be provided to the worker for each skill upon application for a particular job, as may interview questions that relate to each skill. From one or more of these tests and other data, an applicant score may be created.

Once the employer selects a worker for a particular project, the project funds may be made available to a third party escrow service (operation 214), the worker's response time may be evaluated (operation 216), and then the system may perform the job submission rating of the worker (operation 218) and the employer may release funds (operation 220). According to an embodiment of the present invention, the employer and the worker may be provided with the assistance at all stages of the process (operation 222). It is to be understood that for purposes of this disclosure, the worker can be any type of worker, such as a freelancer, part-time employee, contractor, full-time employee, or any other service provider. The employer can be any type of employer who wants to buy services offered by the worker, hire a worker to complete a particular project, to perform a task, or the like.

At a stage of employer account creation (e.g., operation 202, FIG. 2), the system may enable the employer to browse through the web-based application (i.e., web site) when the employer first opens the home web page but the system may not allow the employer to access the site fully until an account is created. Thus, until the time the account has been created, the employer may only be able to see the worker's photos, basic skills and locations but may not be able to see the worker's detailed skills portfolio, job submission ratings, and email response ratings as described in more detail below. The employer may be presented with several technical questions to allow the system to assess the employer's level of technology comfort. Some of the questions that may be asked may be technical in nature to determine if the employer can handle the entire project cycle independently without seeking help, based on the score of the test. If the employer's score is less than a predetermined score, then the system may issue a recommendation for the employer to seek technical expertise. This assessment may not be made mandatory on the web site, and may be optional.

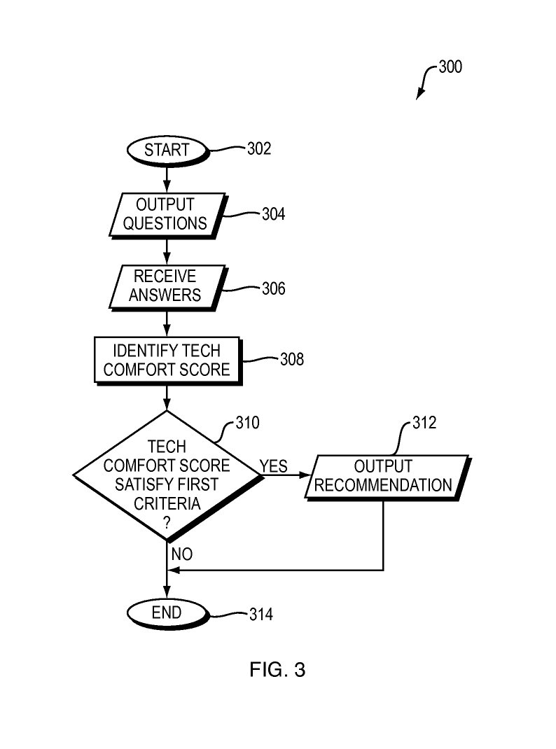

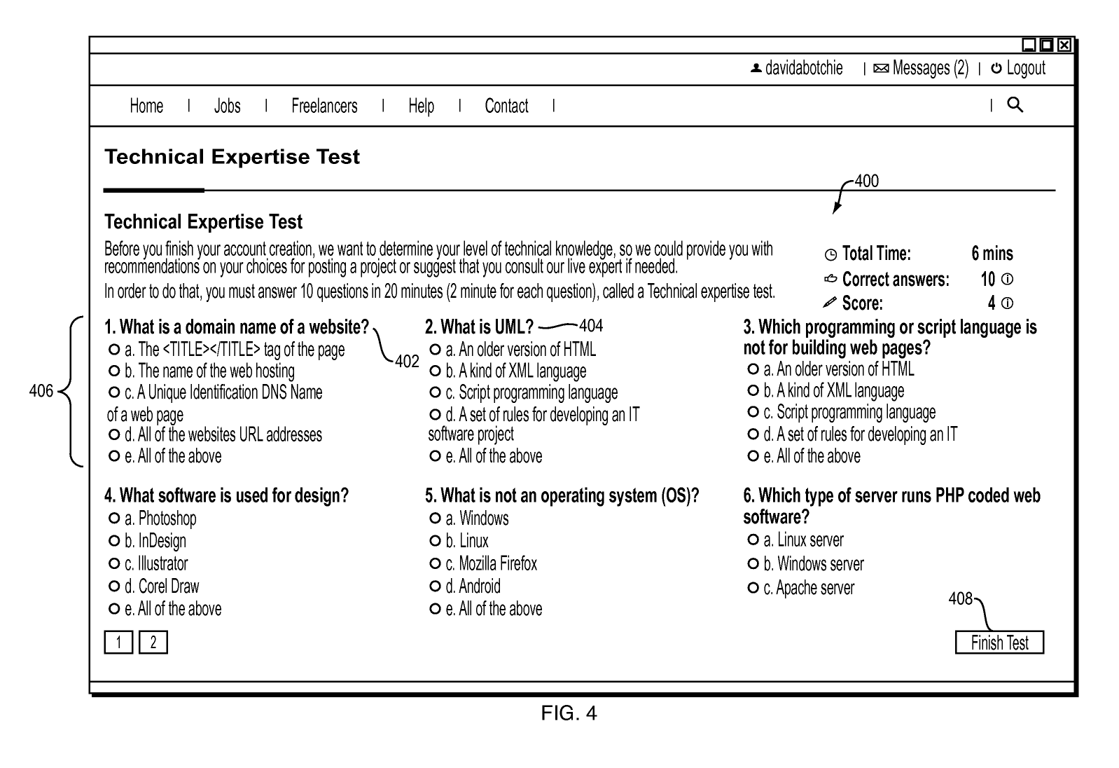

An exemplary operation of the system of FIG. 1 is now described with reference to FIGS.3 and 4. FIG. 3 is a flowchart of an employer technical assessment method 300 according to an embodiment of the present invention. FIG. 4 is a schematic representation of an employer technical assessment user interface 400 according to an embodiment of the present invention.

In operation 302, the method 300 may begin. In operation 304, a first user (e.g., the employer) may be provided with a plurality of outputs representing a plurality of questions relating to the first user's technical skill. For example, the user interface 400 may include question outputs 402, 404 representing the questions “What is a domain name of a website?” and “What is UML?”.

In operation 306, a plurality of inputs may be received from the first user, the plurality of inputs representing a plurality of answers to the plurality of questions. For example, the user interface 400 may include answer outputs 406 that may be displayed with the question outputs 402, 404, the answer outputs representing answers to the questions. The first user may select an answer output for each of the question outputs and submit the selected answer inputs by selecting a submit control 408, thereby generating the plurality of inputs received by the method 300 300.

In operation 308, a technical comfort score may be identified, the technical comfort score representing the first user's comfort with technology. For example, a technical comfort score may be calculated according to the following:

B=A−C

A may equal a total number of questions presented to the first user in the employer technical assessment method 300, B may equal a number of correct answers received from the first user in the employer technical assessment method 300, and C may equal a number of wrong answers received from the first user in the employer technical assessment method 300. The particular equation shown above for calculating the technical comfort score is merely one example and does not constitute a limitation of the present invention.

In operation 310, a determination may be made whether the technical comfort score satisfies a first criterion. The determination may be whether or not the technical comfort score is less than a first threshold value. For example, a required score D of correct answers to pass the employer technical assessment may be set to 70%. A percentage E of correct answers received from the first user may be expressed as a percentage according to the following:

E=(B*100)/A

If E is greater than or equal to D, then it may be determined that the technical comfort score does not satisfy the first criterion. If E is less than D, then it may be determined that the technical comfort score satisfies the first criterion.

The method 300 may further include operation 312. If it is determined in operation 310 that the technical comfort score satisfies the first criterion (i.e., the required score D of correct answers to pass the employer's technical assessment is not met), output may be provided to the first user representing a recommendation that the first user obtain technical assistance when evaluating a worker (operation 312) and the method 300 may end 314. The output to the first user may be a message (e.g., an email message) to the employer requesting that the employer seek expert technical help. If it is determined in operation 310 that the technical comfort score does not satisfy the first criterion (i.e., the required score D of correct answers to pass the employer's technical assessment is met), then the output representing the recommendation that the first user obtain technical assistance when evaluating the worker may not be output to the first user and the method 300 may end 314.

In another embodiment, a further determination may be made regarding the technical comfort score. For example, a determination may be made whether the technical comfort score is greater than a second threshold value and no greater than the first threshold value. If the technical comfort score is greater than the second threshold value and no greater than the first threshold value, then second output may be provided to the first user. After the technical assessment, the employer's account may be created once the employer chooses to create a profile and provides required information.

Next, the employer may begin to post a job at which stage (e.g., operation 204, FIG. 2) the employer may undergo operations of an automated education guidance system to help streamline the job posting experience. In an embodiment, all employers may undergo operations of the automated education guidance system. In another embodiment, only certain employers may undergo operations of the automated education guidance system. For example, input may be received from the employer representing a first part of a job listing. If the technical comfort score satisfies the first criterion, then output for potential inclusion in the job posting may be provided to the employer. The output for potential inclusion in the job posting may represent, for example, a name of a job or a budget for a job. A selection of part of the output may be received from the employer and the selected part of the output may be included in the job listing.

Among other things, the automated education guidance system may be designed to help educate the employer as to the job specification details that the employer may provide to the worker.

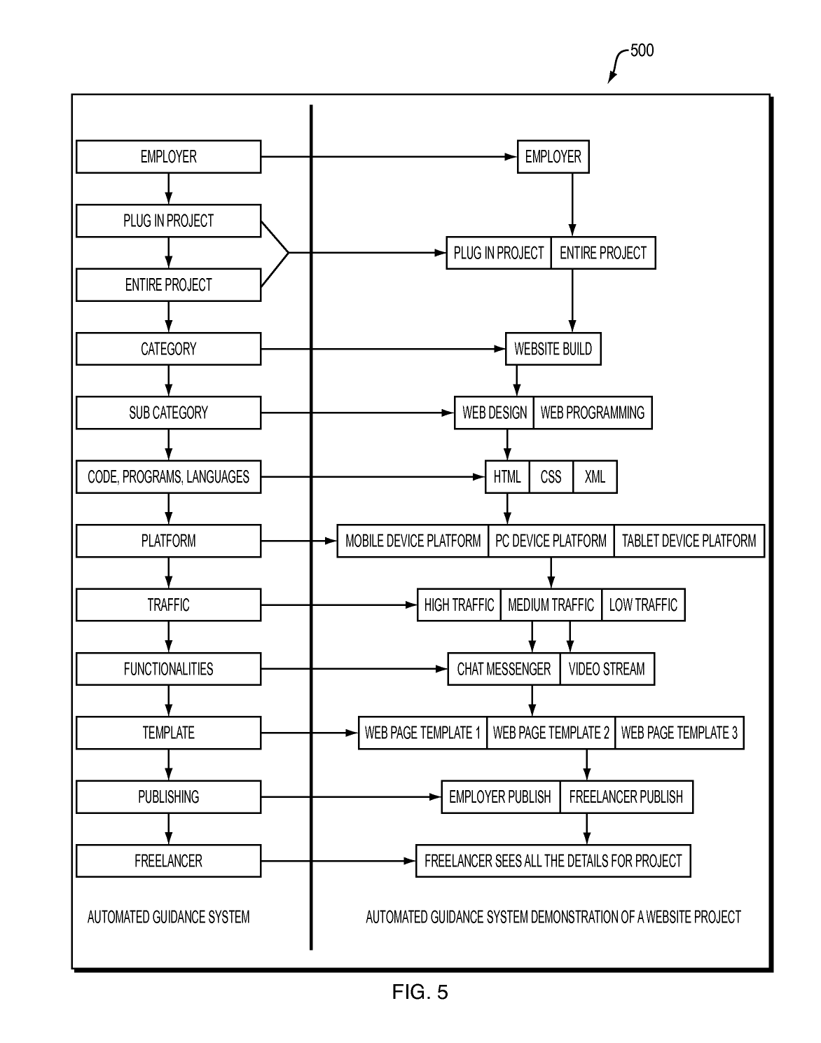

FIG. 5 is a schematic representation of an automated education guidance system and job specification tool 500 to help the employer to streamline the job specification, according to an embodiment of the present invention. Although not so limited, the job specification tool of FIG. 5 is shown for a website project. When the employer is ready to post a job, the employer may be prompted to use the automated educational guidance system and may be presented with a choice of posting a job for a so-called “plug in” project (a small piece of work to be done by a worker, which can be a code plug in or a customized job designed to fit into a project being worked on by a different person, i.e., a sub-project), or for an entire project to be completed by the worker from the beginning to the end.

After the employer chooses the type of project, the employer may be prompted to select a category, at which stage the automated system may prompt the user to select a project category, such as for example, building a web site (as shown in FIG. 5). The system may enable the employer to further select a sub-category, at which stage the system may educate the user about possible sub-categories that may be involved in a project, such as a web design, or web programming, for example, and the difference between the available subcategories. Thus, the system may enable the employer to make an informed decision on what path to take with regard to the category and sub-category of a project. Then, the system may guide the employer through the selection of technologies (e.g., codes, programs, languages, etc.), at which stage the employer may be being educated on the different technologies available for accomplishing a project of interest (e.g., HTML, CSS, or XML).

The system may further educate the user on pros and cons of using all the technologies listed. The employer may then make a selection and proceed to the next operation. The automated guidance system may also educate the employer as to the platforms available for the project (e.g., a PC platform, mobile platform, tablet platform, etc.). The employer may then make a selection to proceed to the next operation. The employer then may make a selection of the web site traffic to be handled by the product produced in the project, such as high, medium, or low traffic, for example. Higher traffic may mean the product to be built by the worker must be agile and robust. The employer may make a selection and proceed to the next operation, which may be a selection of the functionalities to be implemented by the product produced in the project. At this stage, the system may educate the employer on the importance of stating and selecting the functionalities that the project may require in order for the worker to be able to build a product according to the functionalities specified and selected by the employer. An example of such functionalities is a video stream in a web site.

The employer may also be presented with a choice of different templates, at which stage the system may educate the employer on the importance of using a template to describe the project to be performed by the worker. According to an embodiment of the present invention, the employer may select a publishing choice, at which stage the system may educate the employer on the ways and methods the completed work may be deployed. For example, when a web site is completed, it may be published by either the employer or the worker. If the employer chooses that the web site is to be published by the worker, then the worker may need credential access to the employer's web server in order to publish the web site. After the employer makes all the selections, the information from the previous operations may become available to the worker, so that the worker has a detailed description or specification for the project to work on.

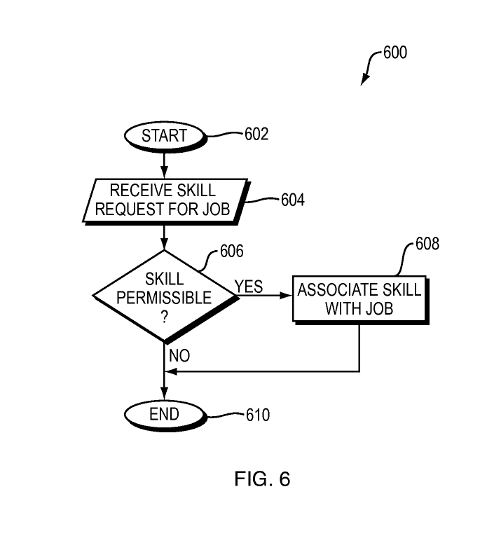

An exemplary operation of the system of FIG. 1 is now described with reference to FIG. 6, which is a flowchart of a skills guidance method 600 according to an embodiment of the present invention.

In operation 602, the method 600 may begin. In operation 604, input representing a skill required for a job may be received from a first user. The job may be associated with a first job category.

In operation 606, a determination may be made whether the skill is a permissible skill to associate with jobs associated with the first category. The determination may include determining whether the skill is in a set of permissible skills associated with the first job category. The determination may include determining if the skill is in a set of impermissible skills associated with the first job category and determining that the skill is a permissible skill to associate with jobs associated with the first job category only if the skill is not determined to be in the set of impermissible skills associated with the first job category.

If it is determined that the skill is a permissible skill to associate with jobs associated with the first job category in operation 606, then the skill may be associated with a job profile associated with the job (operation 608) and the method 600 may end 610. If it is determined that the skill is not a permissible skill to associate with the first job category, then the skill may not be associated with the job profile associated with the job and the method 600 may end 610. The job profile associated with the job may include, for example, a project name, a project description, the first job category, and a price estimate.

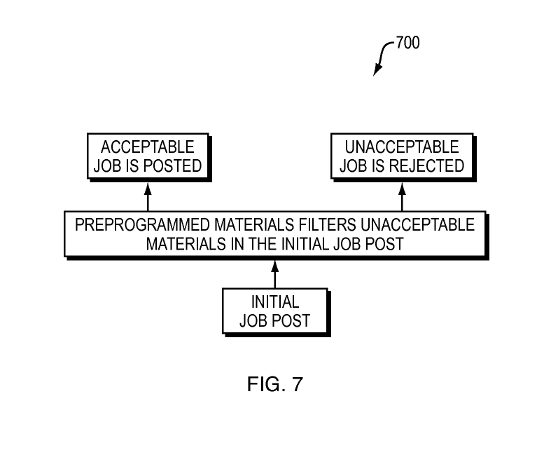

At the job post screening stage, as illustrated in FIG. 7, the automated system may screen the job description (created by the employer using the automated guidance system as described above) for potential foul language and any unacceptable materials in the job post. The system may be preprogrammed with foul language and unacceptable materials in a database to use as a standard to screen and flag unacceptable materials. The screened job description may then be posted and an email may be sent to all the worker's registered in the database with the job skills required for the job to apply.

At the stage of the worker account creation (e.g., operation 208, FIG. 2), the worker may be able to browse through jobs but may not be able to access the site until an account is created or the worker logs into an existing account to see the jobs. The worker then may create a profile (i.e., resume) by entering his or her personal information on the website. At this stage, the worker may have a zero rating on record. The worker may opt to have his/her credentials verified. In some embodiments of the present invention, a verification process may be conducted using biometric data to verify the credentials of the worker. In some embodiments of the present invention, the biometric data may be used for verification of the worker's credentials as well. The automated system may be configured to not allow the account creation to be completed until the worker has selected his/her skill sets on the website.

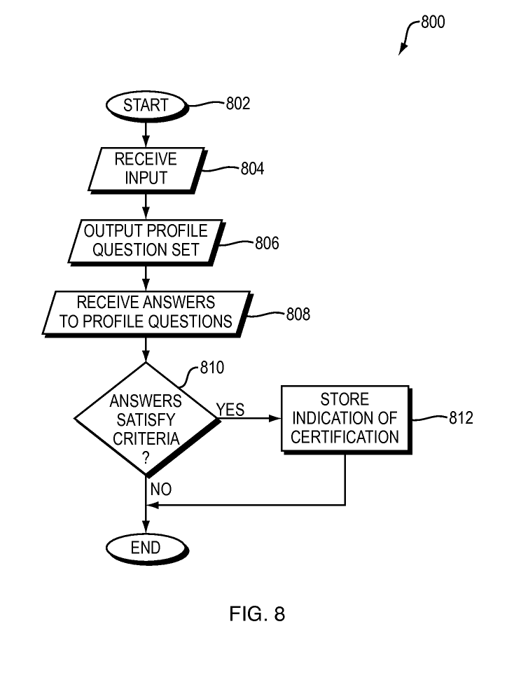

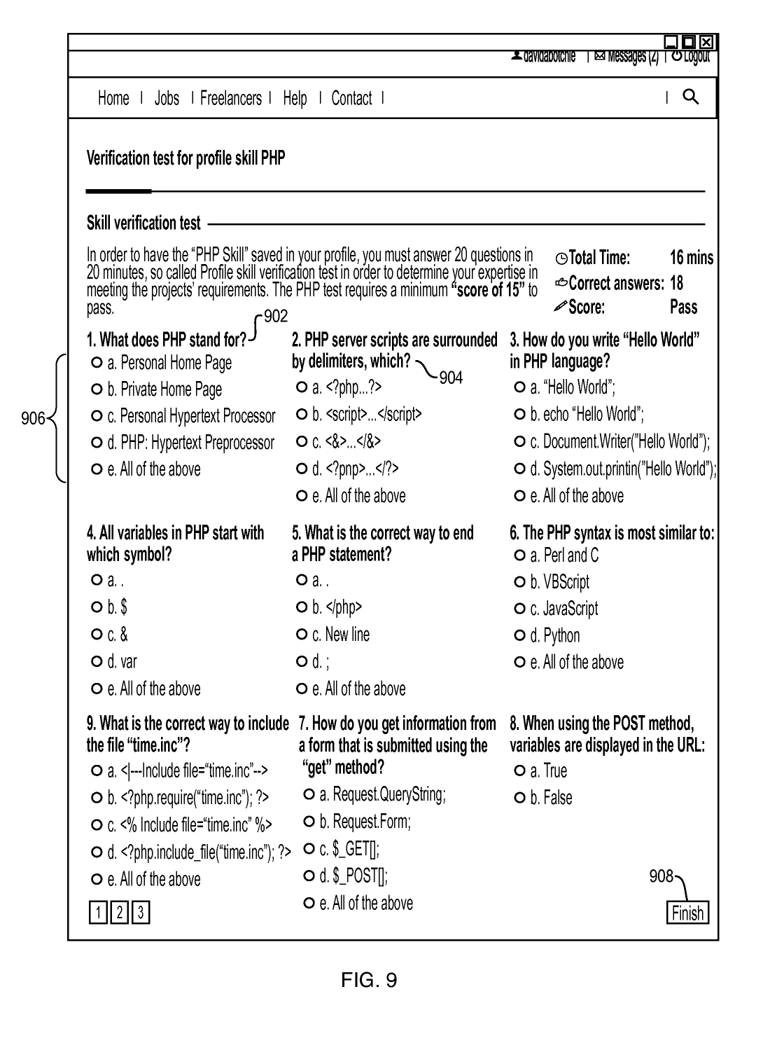

Once the worker picks the skill set he or she believes to be good at, a quiz (i.e., profile test) may be provided to the worker and be used to determine whether the worker actually is skilled in those skill areas that were preselected by the worker. For example, for each skill for which the applicant/worker scores at least a predetermined minimum score (e.g., at least 70% of answers correct for that skill), the system may list that skill on the worker's profile once the worker's account setup is complete. That is, the system may indicate that the worker is certified in a particular skill, as discussed in more detail with reference to FIGS. 8 and 9. The system may omit from the worker's profile any skills for which the worker's score is below the predetermined minimum score (e.g., more than 3 questions out of 10 questions are incorrect). This method may, in other words, be used to validate the skills at which the worker claims to be proficient. The worker may be presented with an option to retake the test later and to improve the quiz score so the system can list those skills on the worker's profile if the worker's scores on the retaken test exceed the predetermined minimum threshold. In some embodiments of the present invention, the applicant/worker may log into his or her account only after the biometric data is verified. If the biometric capture process fails, the worker may be asked to try it again. At this stage, the worker may view the posted job but may not be able to apply until an automated aptitude test, an interview test, and a download speed test have been conducted (e.g., operation 210, FIG. 2).

An exemplary operation of the system of FIG. 1 is now described with reference to FIGS. 8 and 9. FIG. 8 is a flowchart of a worker skill verification method 800 according to an embodiment of the present invention. FIG. 9 is a schematic representation of a worker skill verification user interface 900 according to an embodiment of the present invention.

In operation 802, the method 800 may begin. In operation 804, input representing a plurality of skills may be received from a worker. For each skill S in the first plurality of skills, operations 806 through 812 may be performed. In operation 806, a profile question set Pₛ associated with the skill S may be provided to the worker. For example, the user interface 900 may include question outputs 902, 904 representing the questions “What does PHP stand for?” and “PHP server scripts are surrounded by delimiters, which?”.

In operation 808, an answer to each question in the profile question set Pₛ may be received from the worker. For example, the user interface 900 may include answer outputs 906 that may be displayed with the question outputs 902, 904. The worker may select an answer output for each of the question outputs and submit the selected answer inputs by selecting a submit control 908.

In operation 810, a determination may be made whether the answers received in operation 808 satisfy a criterion. If it is determined that the answers satisfy the criterion in operation 810, an indication that the worker is certified in skill S may be stored in a profile of the worker (operation 812) and the method 800 may end (operation 814). If it is determined that the answers do not satisfy the criterion in operation 810, the method may 800 may end.

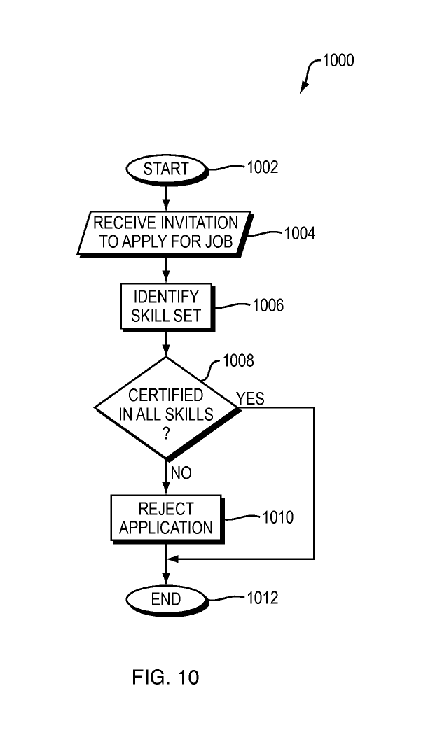

An exemplary operation of the system of FIG. 1 is now described with reference to FIG. 10, which is a flowchart of a certification screening method 1000 according to an exemplary embodiment of the present invention.

In operation 1002, the method 1000 may begin. In operation 1004, input representing an intent to apply for a job may be received from a worker. In operation 1006, a skill set associated with the job may be identified. The skill set may include at least one skill.

In operation 1008, a determination may be made whether a profile of the worker indicates that the worker is certified in all of the skills in the skill set associated with the job. If it is determined in operation 1008 that the profile of the worker indicates that the worker is not certified in all of the skills in the skill set associated with the job, then an application of the worker may be rejected (operation 1010) and the method 1000 may end (operation 1012). If it is determined in operation 1008 that the profile of the worker indicates that the worker is certified in all of the skills in the skill set associated with the job, then the application of the worker may not be rejected and the method 1000 may end (operation 1012).

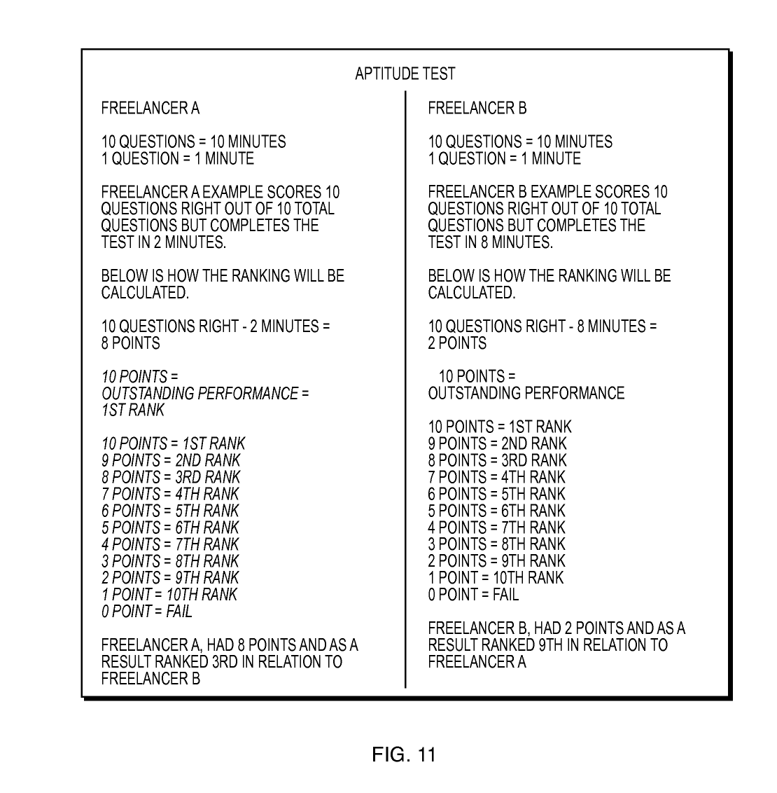

According to some methods of the present invention, an aptitude test may be automatically generated based on requirements that may have been provided by the employer in operation 204, FIG. 2 as described above. As noted above, a worker may be prevented from taking the aptitude test for a particular job or from progressing further in applying for a particular job if the results of the worker's profile test indicates that the worker is not proficient (i.e., certified) in all of the skills required by the particular job. The aptitude test may be a timed test of 10 questions, for example, and these questions may be populated from a database of the automated system. The test may be a set of multiple-choice questions. The test may be administered for a predetermined time (e.g., the duration of the test may be 10 minutes). Workers may be ranked based on the number of correct answers and on the time of completing the test, as shown in FIG. 11, for example. As noted above, the actual quantity of, e.g., aptitude tests may differ. For example, an aptitude test may be given for each skill required by a particular job. Alternatively, a single test including questions corresponding to a plurality of skills may be administered. The worker's test scores for all categories of the automated test may be posted on the worker's online profile and also may be made available for the online/registered employer to see. During the worker's continuous presence on the website, the overall accumulated test score average may be displayed on the worker's profile as well. The system may be configured to allow the worker to send feedback on how to improve the test.

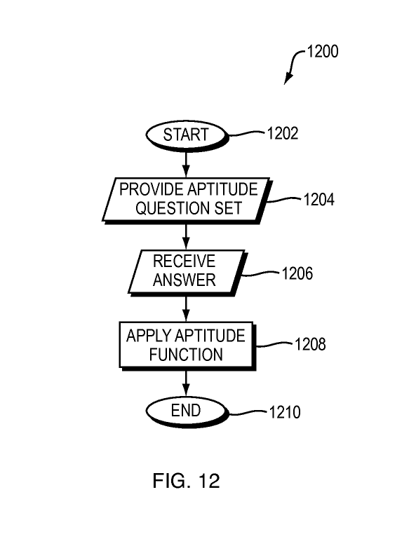

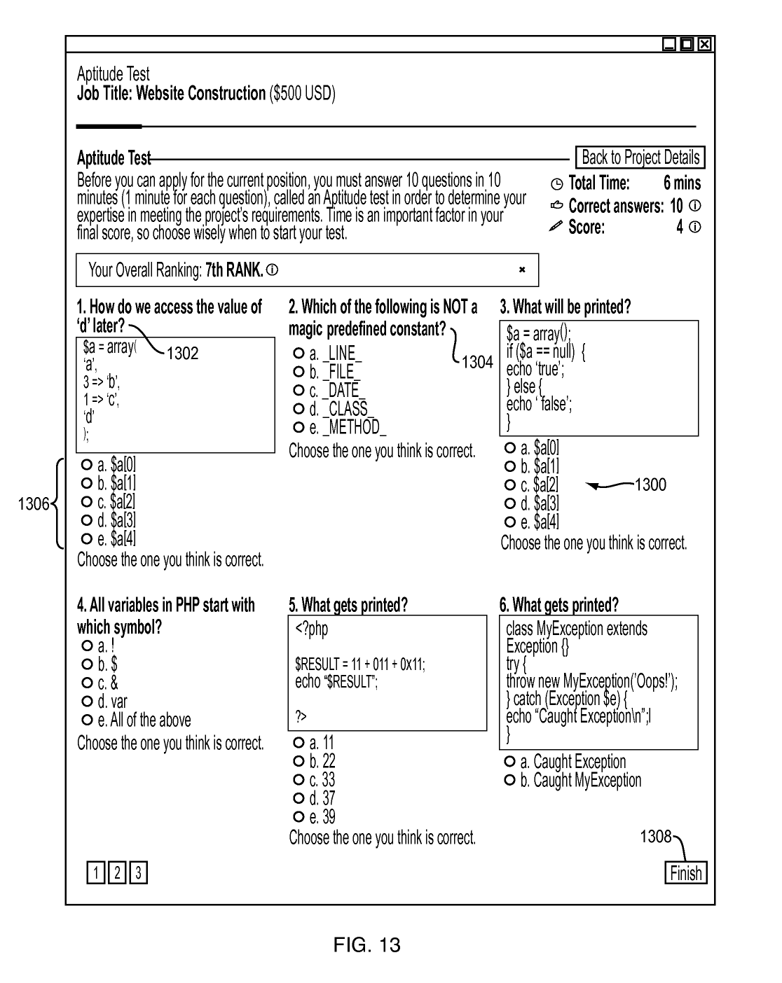

An exemplary operation of the system of FIG. 1 is now described with reference to FIGS. 12 and 13. FIG. 12 is a flowchart of an aptitude assessment method 1200 according to an embodiment of the present invention. FIG. 13 is a schematic representation of an aptitude assessment user interface 1300 according to an embodiment of the present invention.

In operation 1202, the method 1200 may begin. In operation 1204, a first user (e.g., the worker) may be provided with aptitude question set Aₛ associated for each skill T associated with a skill set associated with a job. For example, the user interface 1300 may include question outputs 1302, 1304 representing the questions “How do we access the value of ‘d’ later?” and “Which of the following is NOT a magic predefined constant?”.

In operation 1206, an answer to each question in the aptitude question set Aₛ may be received from the worker. For example, the user interface 1300 may include answer outputs 1306 that may be displayed with the question outputs 1302, 1304, the answer outputs representing answers to the questions. The worker may select an answer output for each of question in the aptitude question set Aₛ and submit the selected answer inputs by selecting a submit control 1308, thereby generating each answer received by the method 1200.

In operation 1208, an aptitude function may be applied to the answers received in operation 1206 to produce an aptitude score associated with the worker and the job.

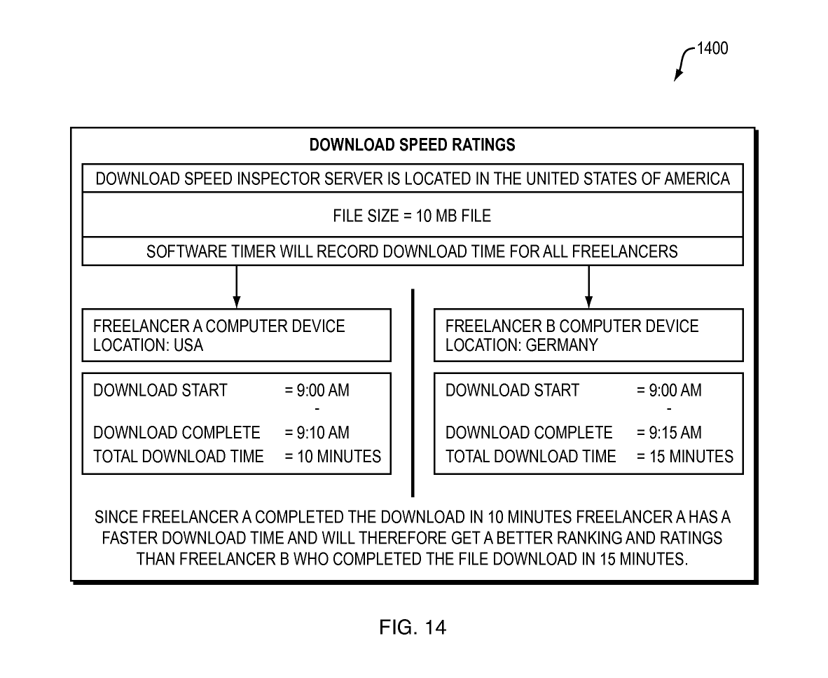

The system may be configured to conduct a technical feature assessment. For example, the system may be configured to conduct a download/upload speed test and rank workers based on the test results as shown in FIG. 14. The download/upload speed test may be conducted by requiring the workers to download/upload the same file, having a particular file size, from a web site onto their personal computer devices. The workers may be ranked based on the download/upload speed or bandwidth. The download/upload speed results may be job-specific. The results may be recorded and posted on the worker's profile for the specific job being applied for only. Other technical feature assessments may include specific hardware and/or software assessments.

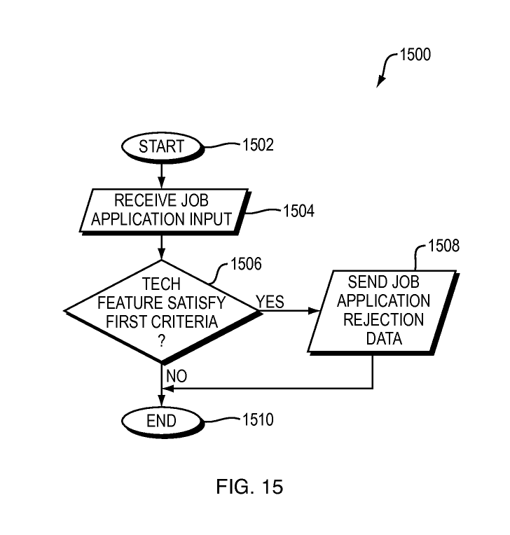

An exemplary operation of the system of FIG. 1 is now described with reference to FIG. 15, which is a flowchart of a technical feature assessment method 1500 according to an embodiment of the present invention.

In operation 1502, the method 1500 may begin. In operation 1504, job application input representing a job application of a job applicant may be received from a second computer. The job application input may include technical feature data representing a technical feature associated with the second computer.

In operation 1506, a determination may be made whether the technical feature data satisfies a first criterion. The determination may be whether a bandwidth of a network connection between the first computer and the second computer is greater than a predetermined threshold value. The determination may be whether a maximum download speed of the second computer over a network connection between the first computer and the second computer is greater than a predetermined threshold value.

If it is determined that the technical feature data satisfies the first criterion in operation 1506, job application rejection data indicating a rejection of the job application may be sent to a first computer (operation 1508) and the method 1500 may end (operation 1510). If it is determined that the technical feature data does not satisfy the first criterion in operation 1506, the method 1500 may end (operation 1510).

According to some methods of the present invention, the system may generate a template with interview questions to help the employer to conduct an interview with the worker. The template may be generated based on the requirements that were provided by the employer in operation 204, FIG. 2 using an automated educational guidance system and job specification tool as described above. The interview test questions may relate to the particular skills required by the particular job.

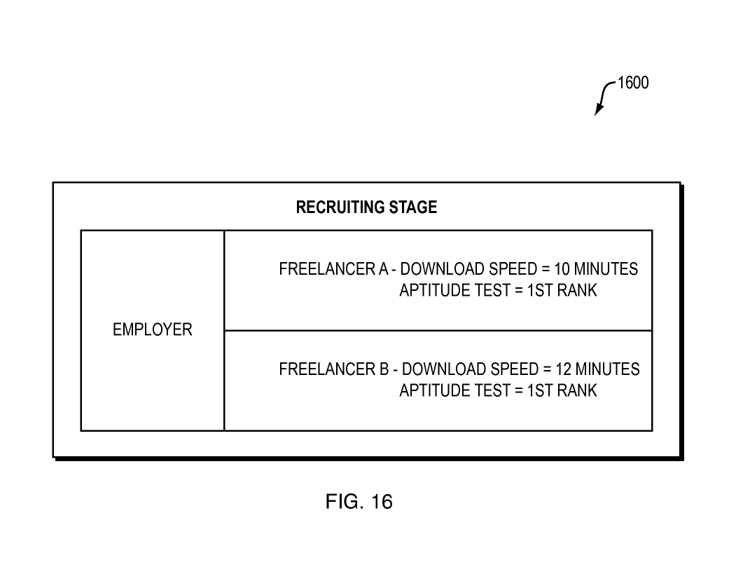

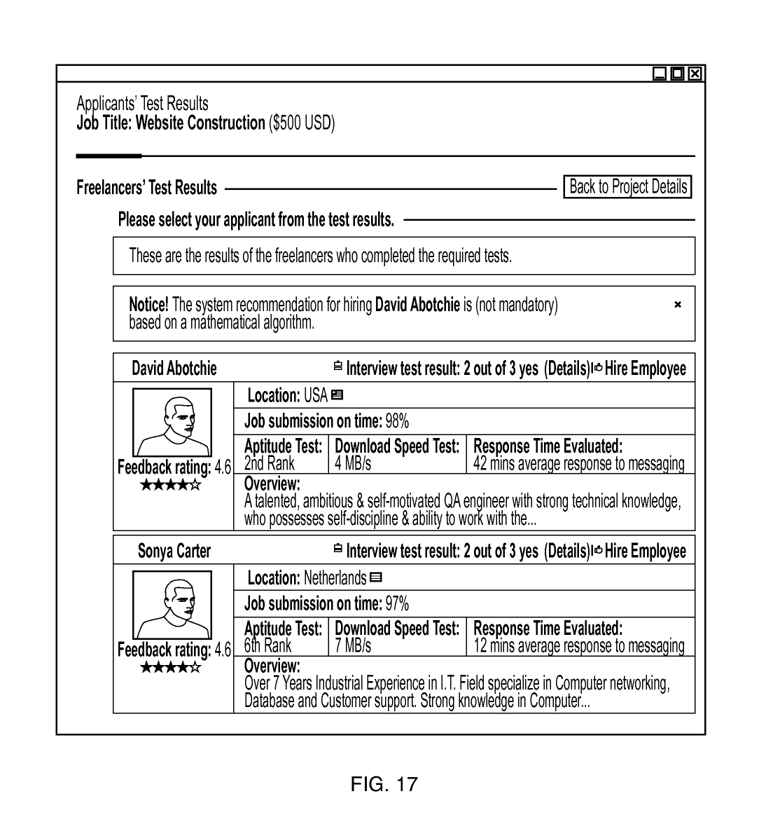

During the recruiting stage, as illustrated in FIGS. 16 and 17, the employer may view all the test results and make a hiring decision based on the test scores, for example. The job specification generated using an automated system (operation 204, FIG. 2) may be made available for the worker to see and review at this stage of the process. Negotiations may also be conducted at this stage to set a job completion date, or the amount the worker may charge to the job done, or the like. Once both the employer and the worker have come to an agreement, the employer may enter the agreed terms into the automated software for both parties to see and review. The worker may affirm (agree to) the terms of the agreement or decline some terms or all terms. The employer can choose a different applicant/worker to proceed with the job application, if the negotiations with the first worker failed.

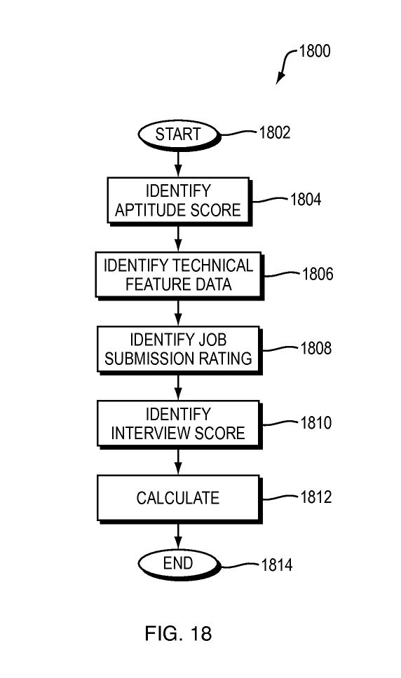

An exemplary operation of the system of FIG. 1 is now described with reference to FIG. 18, which is a flowchart of a worker evaluation method 1800 according to an embodiment of the present invention.

In operation 1802, the method 1800 may begin. In operation 1804, an aptitude score of a worker on an aptitude test associated with a plurality of skills may be identified. The aptitude score may represent a number of questions answered correctly by the worker in response to a plurality of questions associated with the plurality of skills. The plurality of skills may be associated with a job.

In operation 1806, technical feature data representing a technical feature associated with a computer of the worker may be identified. The technical feature data may represent a maximum download speed of the computer of the worker. The technical feature data may include a technical feature score.

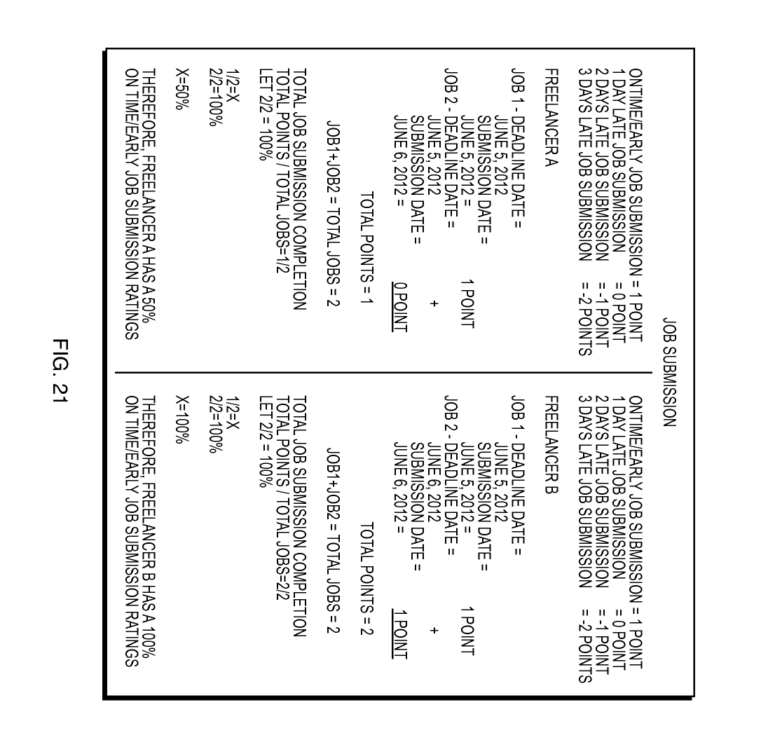

In operation 1808, a job submission rating representing a number of jobs to which the worker has submitted late work assignments may be identified. The number of late job submissions may be identified by reference to the worker's job timeliness counter, as described further with reference to FIG. 21. The job submission rating may be calculated as described below with reference to FIG. 21. The job submission rating may represent a percentage of jobs to which the worker has submitted late work assignments.

In operation 1810, an interview score of the worker on an interview test associated with the job may be identified.

In operation 1812, a job applicant score associated with the worker and the job may be calculated. The job applicant score may be calculated based on the aptitude score, the technical feature data, the job submission rating, and the interview rating. The job applicant score may be influenced indirectly by the worker's profile test score in that if the profile test score is insufficient for the skills required by the particular job, the worker's applicant score may be effectively zero. The job applicant score may be calculated as a linear combination of the aptitude score, the technical feature score, the job submission rating, and the interview score. The linear combination may weight the interview score more heavily than at least one of the aptitude score, the technical feature score, and the job submission rating. The linear combination may weight the interview score more heavily than all of the aptitude score, the technical feature score, and the job submission rating. The linear combination may weight the technical feature score less heavily than at least one of the aptitude score, the job submission rating, and the interview score. The linear combination may weight the technical feature score less heavily than at least one of the aptitude score, the job submission rating, and the interview score. As discussed below, at the completion of a job, an employer and a worker may provide written feedback and a numerical rating for each other. For example, the numerical rating may comprise a five-star rating. For a worker, a worker numerical rating may also be included in calculating the job applicant score. Further, the written feedback may be associated with the worker numerical rating.

If and when the worker agrees to the negotiating terms, the contract may be awarded to the worker and the funds may be deposited into a third party escrow service integrated into the website.

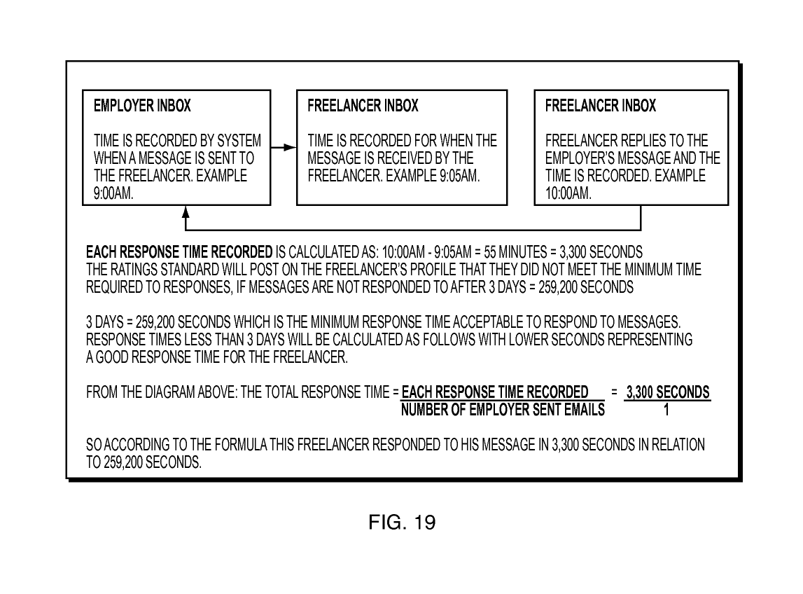

Next, the worker may begin working on the project, during which stage the worker's communication response time may be recorded and used to rate the worker, as for example shown in FIG. 19. The automated system may record the time at which the employer sends a message from his or her computer device and the time at which the communication message was received by the worker. The system may record the time the worker responds to the communication message sent by the worker. The response time may be determined by subtracting the time the worker received the communication message from the time the worker responded to that communication message. The maximum acceptable response time may be set at a predetermined level (e.g., the maximum acceptable time frame for the worker to respond to an email may be 3 days, or 2 days, or 1 day, etc.).

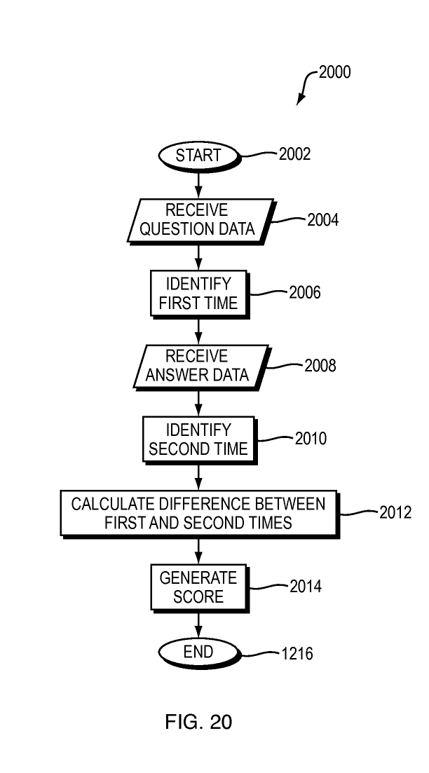

An exemplary operation of the system of FIG. 1 is now described with reference to FIG. 20, which is a flowchart of a communication response time assessment method 2000 in accordance with an embodiment of the present invention.

In operation 2002, the method 2000 may begin. In operation 2004, question data representing a question sent by an employer via a first computer to a second computer associated with a worker may be received. In operation 2006, a first time at which the question was sent by the first computer may be identified.

In operation 2008, answer data representing an answer to the question sent by the worker via the second computer to the first computer may be received. In operation 2010, a second time at which the answer to the question sent by the worker via the second computer to the first computer may be identified.

In operation 2012, a difference between the first time and the second time may be calculated. In operation 2014, a score representing an evaluation of work of the worker may be calculated based on the difference between the first time and the second time. Operations 2004-2012 may be repeated for a plurality of question data and a plurality of answer data, and a statistic (e.g., average) based on differences between the first time and second time for each pair of question and answer data. Operation 2014 may include generating the score based on the statistic. Operation 2014 may include generating a score based on a decreasing function of the difference between the first time and the second time.

At the job submission stage (e.g., operation 218, FIG. 2), the worker may submit the completed work to the server that maintains a job completion database. The worker may be rated by the automated system based on whether or not the job completion date was met by the worker, as shown in FIG. 21 for example. To accomplish this, the system may be configured to record the time at which the completed job is submitted and then to compare that date with the deadline the worker agreed on during negotiations. The rating may be displayed on the worker's profile. Those jobs that were not submitted on time may be approved by the employer before the server may accept a job submission, so the worker can get paid for the completed job. The system may be configured such that the job completion server may not accept a job submission from the worker until approval by the employer is received.

According to some methods of the present invention, the rating system for the job submission may work as follows. As illustrated in FIG. 21, for every job submission submitted on time or earlier than the submission due date, the worker may get 1 point, and then work submitted late by a day may get 0 points deducted from the worker's total job points. If the work is submitted 2 days after the deadline date, 1 point may be deducted from the total points. If the work is submitted 3 days late, 2 points may be deducted from the total points. As this example illustrates, points may be deducted from the worker's total job points as a function of the number of days by which the worker submitted the job late. Maximum days allowed for a late submission may be set at a predetermined value (e.g., 3 days), after exceeding which the worker may risk not getting paid and automatically terminating the project. A timeliness counter of the number of early or late job submissions for each worker may be stored and initialized to zero when the worker's account is created. When a worker submits an individual work assignment early or late, the worker's timeliness counter may be decreased or increased, for example, as discussed above. With some methods of the present invention, additional ratings may be enabled. For example, at the completion of a job, an employer and a worker may provide written feedback and a numerical rating for each other. For example, the numerical rating may comprise a five-star rating. The ratings and written feedback may be provided to subsequent workers and employers.

At the stage of releasing funds by the employer (operation 220, FIG.2), the funds may be released to the worker by the employer if all the job requirements generated in operation 204, FIG. 2 as described above have been met and approved by the employer. When the job is approved by the employer, the payments may be made within a predetermined time (e.g., 3 days, 4 days, etc.) of the job submission and approval or else the system may automatically release the escrow funds to the worker. In case the employer does not approve the job, the funds may be held in the escrow until the dispute is resolved between the employer and the worker.

At each stage of the process described above, the employer as well as the worker may be given an option to consult a live skill expert or experts available to help resolve issues or problems related to the entire process, including technical assistance through the project life cycle, dispute resolution, and so forth.

Among the advantages of the invention are one or more of the following.

One advantage of embodiments of the present invention is that they may be used to assist employers who are not technically skilled in the processes of selecting, tracking, and rating workers who perform technically skilled jobs, such as jobs involving computer programming and web site design. One way in which embodiments of the present invention achieve this benefit is by assisting employers in selecting skills to require of workers based on the nature of the work to be performed by the worker. Technically unsophisticated employers may lack the knowledge even to know which technical skills to require of workers. Embodiments of the present invention address this problem by automatically including particular technical skills in the requirements for particular technical jobs, thereby increasing the likelihood that workers with the correct technical skills will be attracted to apply for those jobs and the likelihood that workers with appropriate skills are hired for those jobs, even if the employer lacks the knowledge to select and test for those skills.

Another way in which embodiments of the present invention assist technically unsophisticated employers is by providing automatic testing and assessment of workers when they apply for jobs. Although workers may select skills that they desire to be included on their profiles, embodiments of the present invention put such self-selected skills to the test and only allow such skills to be included on workers' profiles if those workers pass tests of such skills. As a result, the inclusion of a skill on a worker's profile indicates that the worker has passed an objective test of that skill, not merely that the worker has self-certified himself in the skill. Employers, therefore, may rely to some extent on the validity of the skills listed in each worker's profile when evaluating the relevance of that profile to a particular job. Furthermore, the system may automatically prohibit a worker from applying to jobs that require skills in which the worker's skills have not been certified, thereby saving the employer from the need to consider job applicants who have not been certified in the skills required by the job.

Furthermore, workers may also be tested at the time at which they apply for a job. Such testing, referred to herein as aptitude testing, can be particularly valuable in the context of jobs requiring technical skill because such skills can quickly become outdated. As a result, it may not be sufficient for the employer to rely on the certified skills a worker's profile because such certifications may be outdated by the time the worker applies for a particular job. Aptitude tests provided to a worker at the time of applying for a particular job may be used to generate an aptitude score for that worker in connection with the particular skills required by that job. Such an aptitude score is particularly useful to the employer, therefore, both because it is more up-to-date than the worker's profile and because it is tailored more specifically to the skills required by the job for which the employer is hiring.

Furthermore, workers may also be provided with an interview test when applying for a particular job. Embodiments of the present invention may prompt the employer with possible questions to include in the interview test based on the skills required by the job. This is yet another way in which embodiments of the present invention may assist technically unsophisticated employers in evaluating job applicants for jobs that require technical skills. The employer, however, may select or reject interview test questions, and may modify such questions or write new questions for inclusion in the interview test. As a result, the interview test combines automated assistance to the employer with the ability of the employer to manually include any desired question. The interview test, therefore, provides maximum flexibility to the employer while still assisting the technically unsophisticated employer in evaluating job applicants.

As the examples described above illustrate, another advantage of embodiments of the present invention is that they may be used to assist an employer in evaluating a job applicant. For example, embodiments of the present invention may calculate a job applicant score for a particular job applicant based on an aptitude score of the worker representing the aptitude of the worker in connection with a variety of skills, technical feature data representing a technical feature of the worker's computer (such as the computer's network bandwidth), a job submission rating representing a number of jobs to which the worker has submitted late work assignments, and an interview score of the worker on an interview test associated with the job. Such a job applicant score may be provided to the employer, who may use the job applicant score to determine whether to hire the worker. Generating a single job applicant score which represents multiple dimensions of the worker provides a simple but informative tool for use by the employer in evaluating job applicants.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method operations of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(1) providing, to a first user, a plurality of outputs representing a plurality of questions relating to the first user's technical skill;
(2) receiving, from the first user, a plurality of inputs representing a plurality of answers to the plurality of questions;
(3) identifying, based on the plurality of answers, a technical comfort score representing the first user's comfort with technology; and
(4) determining whether the technical comfort score satisfies a first criterion.

2. The method of claim 1, wherein (4) comprises determining whether the technical comfort score is greater than a first threshold value.

3. The method of claim 2, further comprising:
(5) if the technical comfort score is determined to be greater than the first threshold value, then providing first output to the first user;
(6) determining whether the technical comfort score is greater than a second threshold value and no greater than the first threshold value;
(7) if the technical comfort score is determined to be greater than the second threshold value and no greater than the first threshold value, then providing second output to the first user.

4. The method of claim 1, further comprising:
(5) if the technical comfort score satisfies the first criterion, then providing output to the first user representing a recommendation that the first user obtain technical assistance when evaluating a worker;
(6) if the technical comfort score does not satisfy the first criterion, then not providing the output to the first user representing the recommendation that the first user obtain technical assistance when evaluating the worker.

5. The method of claim 1, further comprising:
(5) receiving input from the first user representing a first part of a job listing;
(6) if the technical comfort score satisfies the first criterion, then providing, to the first user, first output for potential inclusion in the job listing;
(7) receiving, from the first user, input representing a selection of part of the first output; and
(8) including the selected part of the first output in the job listing.

6. The method of claim 5, wherein the first output represents a name of a job.

7. The method of claim 5, wherein the first output represents a budget for a job.

8. The method of claim 1, wherein (3) comprises:
(3)(A) identifying a count A of the plurality of answers;
(3)(B) identifying at least one of a count B of correct answers within the plurality of answers and a count C of incorrect answers within the plurality of answers; and
wherein (4) comprises determining whether the technical comfort score satisfies the first criterion based on A and at least one of B and C.

9. The method of claim 8, wherein (3)(B) comprises:
(3)(B)(i) identifying a minimum threshold D; and
(3)(B)(ii) determining whether B/A is at least as great as the minimum threshold D.

10. The method of claim 8, wherein (3)(B) comprises:
(3)(B)(i) identifying a minimum threshold D; and
(3)(B)(ii) determining whether (A-C)/A is at least as great as the minimum threshold D.

11. A method performed by at least one computer processor executing computer program instructions stored on at least one non-transitory computer-readable medium, the method comprising:
(1) receiving, from a first user, input representing a skill to require for a job, wherein the job is associated with a first job category;
(2) determining whether the skill is a permissible skill to associate with jobs associated with the first job category;
(3) if the skill is determined to be a permissible skill to associate with the first job category, then associating the skill with a job profile associated with the job; and
(4) if the skill is not determined to be a permissible skill to associate with the first job category, then not associating the skill with the job profile associated with the job.

12. The method of claim 11, wherein (2) comprises determining whether the skill is in a set of permissible skills associated with the first job category.

13. The method of claim 11, wherein (2) comprises:
(2)(A) determining whether the skill is in a set of impermissible skills associated with the first job category; and
(2)(B) determining that the skill is a permissible skill to associate with jobs associated with the first job category only if the skill is not determined to be in the set of impermissible skills associated with the first job category.

14. The method of claim 11, wherein the job profile associated with the job includes at least a project name, a project description, the first job category, and a price estimate.

15. A method performed by at least one computer processor executing computer program instructions stored on at least one non-transitory computer-readable medium, the method comprising:
(1) identifying an aptitude score of a worker on an aptitude test associated with a plurality of skills, wherein the plurality of skills is associated with a job;
(2) identifying technical feature data representing a technical feature associated with a computer of the worker;
(3) identifying a job submission rating representing a number of jobs to which the worker has submitted late work assignments;
(4) identifying an interview score of the worker on an interview test associated with the job; and
(5) calculating a job applicant score associated with the worker and the job based on the aptitude score, the technical feature data, the job submission rate, and the interview score.

16. The method of claim 15, wherein the aptitude score represents a number of questions answered correctly by the worker in response to a plurality of questions associated with the plurality of skills.

17. The method of claim 15, wherein the technical feature data represents a maximum download speed of the computer of the worker.

18. The method of claim 15, wherein the job submission rating represents a percentage of jobs to which the worker has submitted late work assignments.

19. The method of claim 15, wherein the technical feature data comprises a technical feature score, and wherein (5) comprises calculating the job applicant score as a linear combination of the aptitude score, the technical feature score, the job submission rating, and the interview score.

20. The method of claim 19, wherein the linear combination weights the interview score more heavily than at least one of the aptitude score, the technical feature score, and the job submission rating.

21. The method of claim 19, wherein the linear combination weights the interview score more heavily than all of the aptitude score, the technical feature score, and the job submission rating.

22. The method of claim 19, wherein the linear combination weights the technical feature score less heavily than at least one of the aptitude score, the job submission rating, and the interview score.

23. The method of claim 19, wherein the linear combination weights the technical feature score less heavily than all of the aptitude score, the job submission rating, and the interview score.

24. The method of claim 15, further comprising:
(6) identifying a worker numerical rating representing at least one employer rating of the worker,
wherein (5) comprises calculating the job applicant score based on the worker numerical rating.

25. The method of claim 24, wherein employer written feedback is associated with the worker numerical rating.

26. A method performed by at least one computer processor executing computer program instructions stored on at least one non-transitory computer-readable medium, the method comprising:
(1) receiving, from a worker, input representing a first plurality of skills;
(2) for each skill S in the first plurality of skills:
(2)(A) providing, to the worker, a profile question set Pₛ associated with skill S;
(2)(B) receiving, from the worker, an answer to each question in the profile question set Pₛ;
(2)(C) determining whether the answers received in (2)(B) satisfy a criterion;
(2)(D) storing, in a profile of the worker, an indication that the worker is certified in skill S only if the answers received in (2)(B) are determined to satisfy the criterion.

27. The method of claim 26, further comprising:
(3) receiving, from the worker, input representing an intent to apply for a job;
(4) identifying a skill set associated with the job, wherein the skill set contains at least one skill;
(5) determining whether the profile of the worker indicates that the worker is certified in all of the skills in the skill set associated with the job; and
(6) rejecting an application of the worker if the profile of the worker is not determined to indicate that the worker is certified in all of the skills in the skill set associated with the job.

28. The method of claim 27, further comprising:
(7) if the profile of the worker is determined to indicate that the worker is certified in all of the skills in the skill set associated with the job, then, for each skill T in the skill set associated with the job:
(2) (A) providing, to the worker, an aptitude question set Aₛ associated with skill T;
(2) (B) receiving, from the worker, an answer to each question in the aptitude question set Aₛ; and
(8) applying an aptitude function to the answers received in (2)(B) to produce an aptitude score associated with the worker and the job.

29. The method of claim 28, further comprising:
(8) for each skill T in the skill set associated with the job:
(8)(A) receiving, from an employer, an interview question set Iₛ associated with skill T;
(8)(B) receiving, from the worker, an answer to each question in the interview question set Iₛ; and
(9) applying an interview function to the answers received in (8)(B) to produce an interview score associated with the worker and the job.

30. The method of claim 29, wherein (8)(A) comprises:
(8)(A)(i) providing output to the employer representing a plurality of questions associated with skill T;
(8)(A)(ii) receiving input from the employer representing at least one of the plurality of questions; and
(8)(A)(iii) including the at least one of the plurality of questions in the interview question set Iₛ.

31. A method performed by at least one computer processor, in a first computer, executing computer program instructions stored on at least one non-transitory computer-readable medium, the method comprising:
(1) obtaining, from a second computer, job application input representing a job application of a job applicant, the job application input comprising technical feature data representing a technical feature associated with the second computer;
(2) determining whether the technical feature data satisfies a first criterion; and
(3) if the technical feature data is determined to satisfy the first criterion, then sending, to the first computer, job application rejection data indicating a rejection of the job application.

32. The method of claim 31, wherein (2) comprises determining whether a bandwidth of a network connection between the first computer and the second computer is greater than a predetermined threshold value.

33. The method of claim 31, wherein (2) comprises determining whether a maximum download speed of the second computer over a network connection between the first computer and the second computer is greater than a predetermined threshold value.

34. A method performed by at least one computer processor executing computer program instructions stored on at least one non-transitory computer-readable medium, the method comprising:
(1) receiving question data representing a question sent by an employer via a first computer to a second computer associated with a worker;
(2) identifying a first time at which the question was sent by the first computer;
(3) receiving answer data representing an answer to the question sent by the worker via the second computer to the first computer;
(4) identifying a second time at which the answer was received by the first computer;
(5) calculating a difference between the first time and the second time; and
(6) generating a score representing an evaluation of work of the worker based on the difference between the first time and the second time.

35. The method of claim 34, further comprising:
(7) repeating (1)-(5) for a plurality of question data and a plurality of corresponding answer data;
(8) calculating a statistic based on differences between the first time and second time for each pair of question and answer data; and
wherein (6) comprises generating the score based on the statistic.

36. The method of claim 35, wherein (8) comprises calculating an average of the differences between the first time and the second time for each pair of question of answer data.

37. The method of claim 34, wherein (6) comprises generating a score based on a decreasing function of the difference between the first time and the second time.

38. A system comprising at least one non-transitory computer-readable medium having computer program instructions stored thereon, the computer program instructions being executable by at least one computer processor to perform a method, the method comprising:
(1) providing, to a first user, a plurality of outputs representing a plurality of questions relating to the first user's technical skill;
(2) receiving, from the first user, a plurality of inputs representing a plurality of answers to the plurality of questions;
(3) identifying, based on the plurality of answers, a technical comfort score representing the first user's comfort with technology; and
(4) determining whether the technical comfort score satisfies a first criterion.

39. The system of claim 38, wherein (4) comprises determining whether the technical comfort score is greater than a first threshold value.

40. The system of claim 39, wherein the method further comprises:
(5) if the technical comfort score is determined to be greater than the first threshold value, then providing first output to the first user;
(6) determining whether the technical comfort score is greater than a second threshold value and no greater than the first threshold value;
(7) if the technical comfort score is determined to be greater than the second threshold value and no greater than the first threshold value, then providing second output to the first user.

41. The system of claim 38, wherein the method further comprises:
(5) if the technical comfort score satisfies the first criterion, then providing output to the first user representing a recommendation that the first user obtain technical assistance when evaluating a worker;
(6) if the technical comfort score does not satisfy the first criterion, then not providing the output to the first user representing the recommendation that the first user obtain technical assistance when evaluating the worker.

42. The system of claim 38, wherein the method further comprises:
(5) receiving input from the first user representing a first part of a job listing;
(6) if the technical comfort score satisfies the first criterion, then providing, to the first user, first output for potential inclusion in the job listing;
(7) receiving, from the first user, input representing a selection of part of the first output; and
(8) including the selected part of the first output in the job listing.

43. The system of claim 42, wherein the first output represents a name of a job.

44. The system of claim 42, wherein the first output represents a budget for a job.

45. The system of claim 38, wherein (3) comprises:
(3)(A) identifying a count A of the plurality of answers;
(3)(B) identifying at least one of a count B of correct answers within the plurality of answers and a count C of incorrect answers within the plurality of answers; and
wherein (4) comprises determining whether the technical comfort score satisfies the first criterion based on A and at least one of B and C.

46. The system of claim 45, wherein (3)(B) comprises:
(3) (B) (i) identifying a minimum threshold D; and
(3) (B) (ii) determining whether B/A is at least as great as the minimum threshold D.

47. The system of claim 45, wherein (3)(B) comprises:
(3)(B)(i) identifying a minimum threshold D; and
(3) (B) (ii) determining whether (A-C)/A is at least as great as the minimum threshold D.

48. A system comprising at least one non-transitory computer-readable medium having computer program instructions stored thereon, the computer program instructions being executable by at least one computer processor to perform a method, the method comprising:
(1) receiving, from a first user, input representing a skill to require for a job, wherein the job is associated with a first job category;
(2) determining whether the skill is a permissible skill to associate with jobs associated with the first job category;
(3) if the skill is determined to be a permissible skill to associate with the first job category, then associating the skill with a job profile associated with the job; and
(4) if the skill is not determined to be a permissible skill to associate with the first job category, then not associating the skill with the job profile associated with the job.

49. The system of claim 48, wherein (2) comprises determining whether the skill is in a set of permissible skills associated with the first job category.

50. The system of claim 48, wherein (2) comprises:
(2)(A) determining whether the skill is in a set of impermissible skills associated with the first job category; and
(2) (B) determining that the skill is a permissible skill to associate with jobs associated with the first job category only if the skill is not determined to be in the set of impermissible skills associated with the first job category.

51. The system of claim 48, wherein the job profile associated with the job includes at least a project name, a project description, the first job category, and a price estimate.

52. A system comprising at least one non-transitory computer-readable medium having computer program instructions stored thereon, the computer program instructions being executable by at least one computer processor to perform a method, the method comprising:
(1) identifying an aptitude score of a worker on an aptitude test associated with a plurality of skills, wherein the plurality of skills is associated with a job;
(2) identifying technical feature data representing a technical feature associated with a computer of the worker;
(3) identifying a job submission rating representing a number of jobs to which the worker has submitted late work assignments;
(4) identifying an interview score of the worker on an interview test associated with the job; and
(5) calculating a job applicant score associated with the worker and the job based on the aptitude score, the technical feature data, the job submission rate, and the interview score.

53. The system of claim 52, wherein the aptitude score represents a number of questions answered correctly by the worker in response to a plurality of questions associated with the plurality of skills.

54. The system of claim 52, wherein the technical feature data represents a maximum download speed of the computer of the worker.

55. The system of claim 52, wherein the job submission rating represents a percentage of jobs to which the worker has submitted late work assignments.

56. The system of claim 52, wherein the technical feature data comprises a technical feature score, and wherein (5) comprises calculating the job applicant score as a linear combination of the aptitude score, the technical feature score, the job submission rating, and the interview score.

57. The system of claim 56, wherein the linear combination weights the interview score more heavily than at least one of the aptitude score, the technical feature score, and the job submission rating.

58. The system of claim 56, wherein the linear combination weights the interview score more heavily than all of the aptitude score, the technical feature score, and the job submission rating.

59. The system of claim 56, wherein the linear combination weights the technical feature score less heavily than at least one of the aptitude score, the job submission rating, and the interview score.

60. The system of claim 56, wherein the linear combination weights the technical feature score less heavily than all of the aptitude score, the job submission rating, and the interview score.

61. The system of claim 52, wherein the method further comprises:
(6) identifying a worker numerical rating representing at least one employer rating of the worker,
wherein (5) comprises calculating the job applicant score based on the worker numerical rating.

62. The system of claim 61, wherein employer written feedback is associated with the worker numerical rating.

63. A system comprising at least one non-transitory computer-readable medium having computer program instructions stored thereon, the computer program instructions being executable by at least one computer processor to perform a method, the method comprising::
(1) receiving, from a worker, input representing a first plurality of skills;
(2) for each skill S in the first plurality of skills:
(2)(A) providing, to the worker, a profile question set Pₛ associated with skill S;
(2)(B) receiving, from the worker, an answer to each question in the profile question set Pₛ;
(2)(C) determining whether the answers received in (2)(B) satisfy a criterion;
(2)(D) storing, in a profile of the worker, an indication that the worker is certified in skill S only if the answers received in (2)(B) are determined to satisfy the criterion.

64. The system of claim 63, wherein the method further comprises:
(3) receiving, from the worker, input representing an intent to apply for a job;
(4) identifying a skill set associated with the job, wherein the skill set contains at least one skill;
(5) determining whether the profile of the worker indicates that the worker is certified in all of the skills in the skill set associated with the job; and
(6) rejecting an application of the worker if the profile of the worker is not determined to indicate that the worker is certified in all of the skills in the skill set associated with the job.

65. The system of claim 64, wherein the method further comprises:
(7) if the profile of the worker is determined to indicate that the worker is certified in all of the skills in the skill set associated with the job, then, for each skill T in the skill set associated with the job:
(2) (A) providing, to the worker, an aptitude question set Aₛ associated with skill T;
(2) (B) receiving, from the worker, an answer to each question in the aptitude question set Aₛ; and
(8) applying an aptitude function to the answers received in (2) (B) to produce an aptitude score associated with the worker and the job.

66. The system of claim 65, wherein the method further comprises:
(8) for each skill T in the skill set associated with the job:
(8)(A) receiving, from an employer, an interview question set Iₛ associated with skill T;
(8)(B) receiving, from the worker, an answer to each question in the interview question set Iₛ; and
(9) applying an interview function to the answers received in (8)(B) to produce an interview score associated with the worker and the job.

67. The system of claim 66, wherein (8)(A) comprises:
(8)(A)(i) providing output to the employer representing a plurality of questions associated with skill T;
(8)(A)(ii) receiving input from the employer representing at least one of the plurality of questions; and
(8)(A)(iii) including the at least one of the plurality of questions in the interview question set Iₛ.

68. A system comprising a first computer and at least one non-transitory computer-readable medium having computer program instructions stored thereon, the computer program instructions being executable by at least one computer processor to perform a method, the method comprising::
(1) obtaining, from a second computer, job application input representing a job application of a job applicant, the job application input comprising technical feature data representing a technical feature associated with the second computer;
(2) determining whether the technical feature data satisfies a first criterion; and
(3) if the technical feature data is determined to satisfy the first criterion, then sending, to the first computer, job application rejection data indicating a rejection of the job application.

69. The system of claim 68, wherein (2) comprises determining whether a bandwidth of a network connection between the first computer and the second computer is greater than a predetermined threshold value.

70. The system of claim 68, wherein (2) comprises determining whether a maximum download speed of the second computer over a network connection between the first computer and the second computer is greater than a predetermined threshold value.

71. A system comprising at least one non-transitory computer-readable medium having computer program instructions stored thereon, the computer program instructions being executable by at least one computer processor to perform a method, the method comprising::
(1) receiving question data representing a question sent by an employer via a first computer to a second computer associated with a worker;
(2) identifying a first time at which the question was sent by the first computer;
(3) receiving answer data representing an answer to the question sent by the worker via the second computer to the first computer;
(4) identifying a second time at which the answer was received by the first computer;
(5) calculating a difference between the first time and the second time; and
(6) generating a score representing an evaluation of work of the worker based on the difference between the first time and the second time.

72. The system of claim 71, wherein the method further comprises:
(7) repeating (1)-(5) for a plurality of question data and a plurality of corresponding answer data;
(8) calculating a statistic based on differences between the first time and second time for each pair of question and answer data; and
wherein (6) comprises generating the score based on the statistic.

73. The system of claim 72, wherein (8) comprises calculating an average of the differences between the first time and the second time for each pair of question of answer data.

74. The system of claim 71, wherein (6) comprises generating a score based on a decreasing function of the difference between the first time and the second time.
